(19) United States
(12) Patent Application Publication
(10) Pub. No.: US 2012/0117029 A1
(43) Pub. Date: May 10, 2012

(54) BACKUP POLICIES FOR USING DIFFERENT STORAGE TIERS

(76) Inventor: Stephen Gold, Fort Collins, CO (US)

(21) Appl. No.: 12/942,006

(22) Filed: Nov. 8, 2010

(51) Int. Cl. G06F 12/16; G06F 17/30

(52) U.S. Cl. 707/651; 707/E17.005

(57) ABSTRACT

Systems and methods of using different storage tiers based on a backup policy are disclosed. An example of a method includes receiving a backup job from a client for data on a plurality of virtualized storage nodes. The method also includes identifying at least one property of the backup job. The method also includes accessing the backup policy for the backup job. The method also includes selecting between storing incoming data for the backup job on the plurality of virtualized storage nodes in a first tier or a second tier based on the backup policy.

### CROSS-REFERENCE TO RELATED APPLICATION

This application is related to co-owned U.S. patent application Ser. No. 12/906,108 entitled “Storage Tiers For Different Backup Types” filed Oct. 17, 2010.

### BACKGROUND

Storage devices commonly implement data backup operations using virtual storage products for data recovery. Some virtual storage products have multiple backend storage devices that are virtualized so that the storage appears to a client as discrete storage devices, while the backup operations may actually be storing data across a number of the physical storage devices.

During operation, the user may desire to make some backup jobs available for faster restore, while archiving other backup jobs. Prior approaches store all backup data the same, regardless of whether the backup data is a full backup, incremental backup, data from a high-priority server, or data from a low-priority server. After a predetermined time, older backup jobs are moved to the archives. This approach results in unnecessarily large amounts of data being stored for faster restore time, while some backup jobs that should remain stored for faster restore time are moved to the archives simply because a predetermined time has passed.

The user may partition the backup device into different targets (e.g., different virtual libraries), such that different backup retention times are grouped together. For example, all weekly full backups go to one target, and the daily full backups go to another target. The user then has different retention times for each target. For example, daily retention for the daily full target, and weekly retention for the weekly full target. Unfortunately, this policy increases the user administration load because now the user cannot just simply direct all backups to a single backup target, and instead has to direct each backup job to the appropriate target.

Forcing the user to choose between consuming a lot of disk space and performing more administrative tasks is counter to the value proposition of an enterprise backup device where the goal is to save disk space and reduce or altogether eliminate user administration tasks.

### BRIEF DESCRIPTION OF THE DRAWINGS

FIG. 1 is a high-level diagram showing an example of a storage system including a plurality of virtualized storage nodes which may be utilized with backup policies for using different storage tiers.

FIG. 2 illustrates an example of software architecture which may be implemented in the storage system with backup policies for using different storage tiers.

FIG. 3 is a flow diagram illustrating operations which may be implemented for using different storage tiers back on a backup policy.

### DETAILED DESCRIPTION

Systems and methods are disclosed which utilize backup policies for using different storage tiers for backup jobs in virtualized storage nodes, for example, during backup and restore operations for an enterprise. It is noted that the term “backup” is used herein to refer to backup operations including echo-copy and other proprietary and non-proprietary data operations now known or later developed. Briefly, a storage system is disclosed including a plurality of physical storage nodes. The physical storage nodes are virtualized as one or more virtual storage devices (e.g., a virtual storage library having virtual data cartridges that can be accessed by virtual storage drives). Data may be backed-up to a virtual storage device presented to the client on the “frontend” as discrete storage devices (e.g., data cartridges). However, the data for a discrete storage device may actually be stored on the “backend” on any one or more of the physical storage devices.

An enterprise backup device may be provided with two or more tiers of storage within the same device. For example, a first tier (e.g., a faster tier) may be used for non-deduplicating storage which stores data in contiguous storage blocks for faster restore times. A second tier (e.g., a slower tier) may be used for deduplication storage which stores data in “chunks” in non-contiguous storage blocks to reduce storage consumption. If a user desires guaranteed backup performance and full restore performance for certain backup jobs, the those backup jobs should be stored on the first tier, while other backup jobs (e.g., lower priority backup jobs) are stored on the second tier based on one or more backup policy.

The systems and methods described herein enable a user (e.g., an administrator or other user) and/or a backup application to assign properties for backup jobs (e.g., metadata specifying the type of backup job, etc.) for use by the backup device in determining how to handle the backup job. For example, incoming backup streams may be decoded to read information in meta-data embedded in the backup streams. In another example, such as with the open storage (OST) backup protocol, the information may be determined from image metadata directly from an image. In any event, the backup device may access one or more backup policies defined by a user or otherwise for handling the backup job on the backup device (e.g., storing the backup job in a first tier or a second tier).

In an embodiment, a system is provided which satisfies service level objectives for different backup jobs. The system includes an interface between a plurality of virtualized storage nodes and a client. The interface is configured to identify at least one property of a backup job from the client for backing up data on a virtualized storage node in one of at least two states. The system also includes a storage manager operatively associated with the interface. The storage manager is configured to manage storing of incoming data for the backup job on the plurality of virtualized storage nodes in either a first tier (e.g., a faster tier for non-deduplicated data) or a second tier (e.g., a slower tier for deduplicated data) based on a backup policy.

The systems and methods described herein enable a user to intelligently control how backup data is stored on the backup device, e.g., based on desired restore characteristics and/or data storage capacity. Certain backup jobs can be stored as nondeduplicated data to provide faster restore times, while other backup jobs can be stored as deduplicated data to reduce disk space usage. Accordingly, users do not need to partition the storage device into multiple smaller targets for each retention scheme, or consume unnecessary disk space in the faster tier due to varying retention schemes.

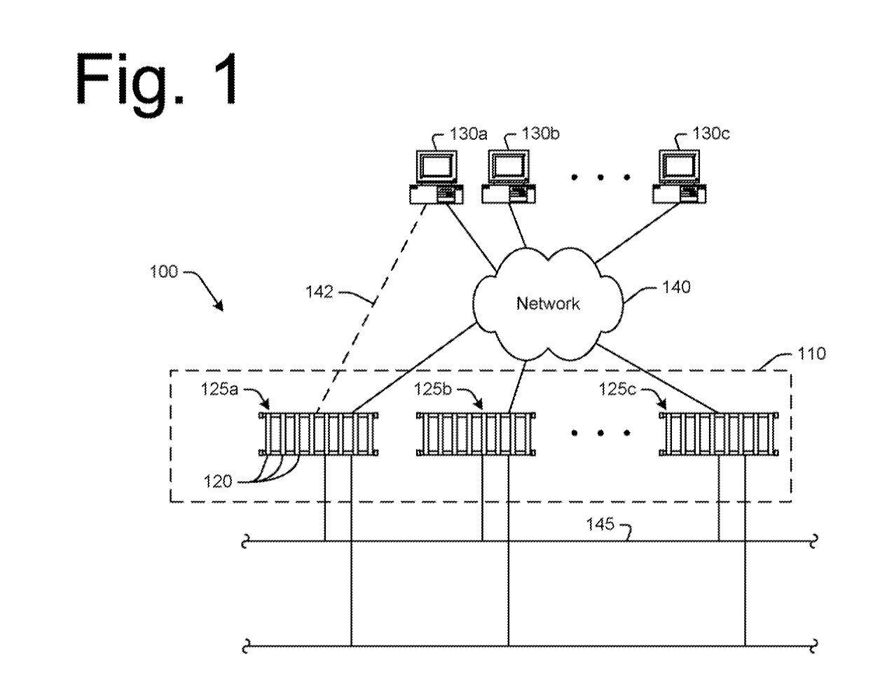

FIG. 1 is a high-level diagram showing an example of a storage system 100 which may be utilized with backup policies for using different storage tiers. Storage system 100 may include a storage device 110 with one or more storage nodes 120. The storage nodes 120, although discrete (i.e., physically distinct from one another), may be logically grouped into one or more virtual devices 125a-c (e.g., a virtual library including one or more virtual cartridges accessible via one or more virtual drive).

For purposes of illustration, each virtual cartridge may be held in a “storage pool,” where the storage pool may be a collection of disk array LUNs. There can be one or multiple storage pools in a single storage product, and the virtual cartridges in those storage pools can be loaded into any virtual drive. A storage pool may also be shared across multiple storage systems.

The virtual devices 125a-c may be accessed by one or more client computing device 130a-c (also referred to as “clients”), e.g., in an enterprise. In an embodiment, the clients 130a-c may be connected to storage system 100 via a “front-end” communications network 140 and/or direct connection (illustrated by dashed line 142). The communications network 140 may include one or more local area network (LAN) and/or wide area network (WAN) and/or storage area network (SAN). The storage system 100 may present virtual devices 125a-c to clients via a user application (e.g., in a “backup” application).

The terms “client computing device” and “client” as used herein refer to a computing device through which one or more users may access the storage system 100. The computing devices may include any of a wide variety of computing systems, such as stand-alone personal desktop or laptop computers (PC), workstations, personal digital assistants (PDAs), mobile devices, server computers, or appliances, to name only a few examples. Each of the computing devices may include memory, storage, and a degree of data processing capability at least sufficient to manage a connection to the storage system 100 via network 140 and/or direct connection 142.

In an embodiment, the data is stored on more than one virtual device 125, e.g., to safeguard against the failure of any particular node(s) 120 in the storage system 100. Each virtual device 125 may include a logical grouping of storage nodes 120. Although the storage nodes 120 may reside at different physical locations within the storage system 100 (e.g., on one or more storage device), each virtual device 125 appears to the client(s) 130a-c as individual storage devices. When a client 130a-c accesses the virtual device 125 (e.g., for a read/write operation), an interface coordinates transactions between the client 130a-c and the storage nodes 120.

The storage nodes 120 may be communicatively coupled to one another via a “back-end” network 145, such as an inter-device LAN. The storage nodes 120 may be physically located in close proximity to one another. Alternatively, at least a portion of the storage nodes 120 may be “off-site” or physically remote from the local storage device 110, e.g., to provide a degree of data protection.

The storage system 100 may be utilized with any of a wide variety of redundancy and recovery schemes for storing data backed-up by the clients 130. Although not required, in an embodiment, deduplication may be implemented for migrating. Deduplication has become popular because as data growth soars, the cost of storing data also increases storage capacity, especially for backup data on disk. Deduplication reduces the cost of storing multiple backups on disk. Because virtual tape libraries are disk-based backup devices with a virtual file system and the backup process itself tends to have a great deal of repetitive data, virtual cartridge libraries lend themselves particularly well to data deduplication. In storage technology; deduplication generally refers to the reduction of redundant data. In the deduplication process, duplicate data is deleted, leaving only one copy of the data to be stored. Accordingly, deduplication may be used to reduce the required storage capacity because only unique data is stored. That is, where a data file is conventionally backed up X number of times, X instances of the data file are saved, multiplying the total storage space required by X times. In deduplication, however, the data file is only stored once, and each subsequent time the data file is simply referenced back to the originally saved copy.

With a virtual cartridge device that provides storage for deduplication, the net effect is that, over time, a given amount of disk storage capacity can hold more data than is actually sent to it. For purposes of example, a system containing 1 TB of backup data which equates to 500 GB of storage with 2:1 data compression for the first normal full backup. If 10% of the files change between backups, then a normal incremental backup would send about 10% of the size of the full backup or about 100 GB to the backup device. However, only 10% of the data actually changed in those files which equates to a 1% change in the data at a block or byte level. This means only 10 GB of block level changes or 5 GB of data stored with deduplication and 2:1 compression. Over time, the effect multiplies. When the next full backup is stored, it will not be 500 GB, the deduplicated equivalent is only 25 GB because the only block-level data changes over the week have been five times 5 GB incremental backups. A deduplication-enabled backup system provides the ability to restore from further back in time without having to go to physical tape for the data.

With multiple nodes (with non-shared back-end storage) each node has its own local storage. A virtual library spanning multiple nodes means that each node contains a subset of the virtual cartridges in that library (for example each node's local file system segment contains a subset of the files in the global file system). Each file represents a virtual cartridge stored in a local file system segment which is integrated with a deduplication store. Pieces of the virtual cartridge are contained in different deduplication stores based on references to other duplicate data in other virtual cartridges.

The deduplicated data, while reducing disk storage space, can take longer to complete a restore operation. It is not so much that a deduplicated cartridge may be stored across multiple physical nodes/arrays, but rather the restore operation is slower because deduplication means that common data is shared between multiple separate virtual cartridges. So when restoring any one virtual cartridge, the data will not be stored in one large sequential section of storage, but instead will be spread around in small pieces (because whenever a new backup is written, the common data within that backup becomes a reference to a previous backup, and following these references during a restore means going to the different storage locations for each piece of common data). Having to move from one storage location to another random location is slower because it requires the disk drives to seek to the different locations rather than reading large sequential sections. Therefore, it is desirable to maintain certain backup jobs in a first tier (e.g., a faster, non-deduplicating tier), while other backup jobs are stored in a second tier (e.g., a slower, deduplicating tier).

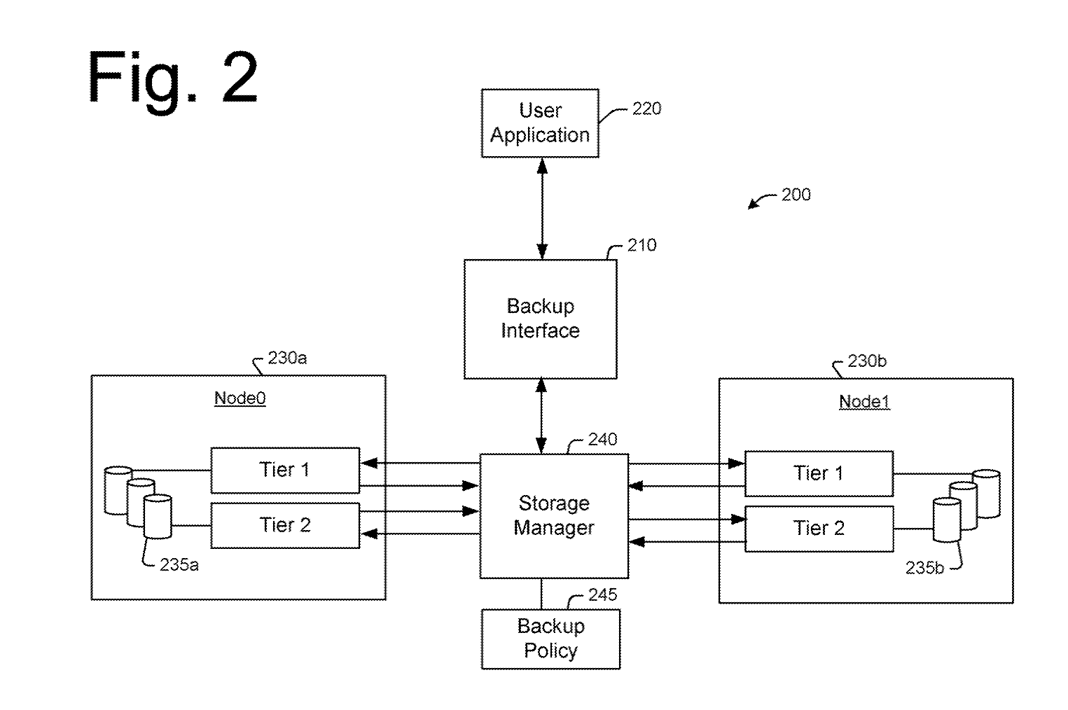

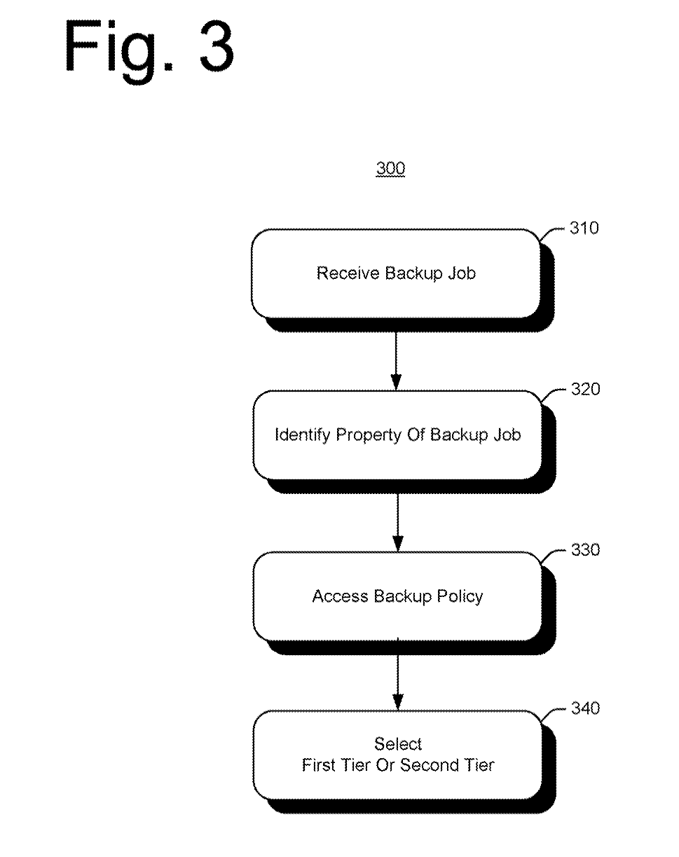

The systems and methods described herein enable the backup device to determine which backup jobs are stored on the different storage tiers. Such systems and methods satisfy service level objectives for different backup jobs in virtualized storage nodes, as will be better understood by the following discussion and with reference to FIGS. 2 and 3.

FIG. 2 shows an example software architecture 200 which may be implemented in the storage system (e.g., storage system 100 shown in FIG. 1) to provide a plurality of storage tiers (e.g., Tier 1 and Tier 2) for different backup jobs. It is noted that the components shown in FIG. 2 are provided only for purposes of illustration and are not intended to be limiting. For example, although only two virtualized storage nodes (Node0 and Node1) and only two tiers (Tier 1 and Tier 2) are shown in FIG. 2 for purposes of illustration, there is no practical limit on the number of virtualized storage nodes and/or storage tiers which may be utilized.

It is also noted that the components shown and described with respect to FIG. 2 may be implemented in program code (e.g., firmware and/or software and/or other logic instructions) stored on one or more computer readable medium and executable by one or more processor to perform the operations described below. The components are merely examples of various functionality that may be provided, and are not intended to be limiting.

In an embodiment, the software architecture 200 may comprise a backup interface 210 operatively associated with a user application 220 (such as a backup application) executing on or in association with the client (or clients). The backup interface 210 may be provided on the storage device itself (or operatively associated therewith), and is configured to identify at least one property of a backup job as the backup job is being received at the storage device from the client (e.g., via user application 220) for backing up data on one or more virtualized storage node 230a-b each including storage 235a-b, respectively. A storage manager 240 for storing/restoring and/or otherwise handling data is operatively associated with the backup interface 210.

The manager 240 is configured to manage migrating of data on at least one other virtualized storage node (e.g., node 230a) in a first tier or a second tier (or additional tiers, if present). The storage manager is configured to select between the first tier and the second tier based on a backup policy.

In an example, the storage manager 240 applies a backup policy 245 that stores certain backup jobs in the first tier, and stores other backup jobs in the second tier, for example on at least one other virtualized storage node (e.g., node 230b). In an example, the first tier is for non-deduplicated data and the second tier is for deduplicated data. Accordingly, the first tier provides faster restore to the client of the backup job than the second tier, and the second tier provides greater storage capacity than the first tier.

For purposes of illustration, in a simple non-deduplication example, the entire contents of a virtual cartridge may be considered to be a single file held physically in a single node file system segment, and accordingly restore operations are much faster than in a deduplication example because the backup job is stored essentially as an “image” across contiguous or substantially contiguous storage blocks on a single (or adjacent) storage nodes.

In a deduplication example, each backup job (or portion of a backup job) stored on the virtual tape may be held in a different deduplication store, and each deduplication store may further be held in a different storage node. In this example, in order to access data for the restore operation, since different sections of the virtual cartridge may be in different deduplication stores, the virtual drive may need to search non-contiguous storage blocks and/or move to different nodes as the restore operation progresses through the virtual cartridge. Therefore, the deduplication tier is slower than the non-deduplication tier.

While non-deduplication is faster, deduplication consumes less storage space. Thus, the user may desire to establish backup policies which utilize both deduplication and non-deduplication.

During operation, the backup interface 210 identifies at least one property of the backup jobs so that backup policy 245 may be used to store the backup job on the appropriate tier. The backup property may include one or more of the following: a name of a client device (e.g., Server1 or Sever2), a name of the backup job (e.g., Daily or Weekly), a type of the backup job (e.g., full or incremental), an origin of the backup job (e.g., High Priority Server or Low Priority Server), a capability of a source of the backup job (e.g., deduplication-enabled servers and deduplication-non-enabled servers). Of course these backup properties are provided merely as illustrative of different backup properties which may be implemented. Other suitable backup properties may also be defined based on any of a wide variety of considerations (e.g., corporate policy, recommendations of the manufacturer or IT staff, etc.).

The backup policy may be defined based on one or more of the backup properties. For example, the backup policy may include instructions for routing high priority backup jobs to the first tier, and lower priority backup jobs to the second tier. Of course the backup policies may be more detailed, wherein if a first condition is met, then another backup property is analyzed to determine if a nested condition is met, and so forth, in order to store the backup job (or portion of the backup job) in the desired tier.

The backup device is configured to obtain at least some basic level of awareness of the backup jobs being stored, in terms of backup job name and job type (e.g., full and incremental). One example for providing this awareness is with the OST backup protocol, where the backup job name and type are encoded in the meta-data provided by the OST interface whenever a new backup image is sent to the backup device. Thus, whenever an OST image (with metadata) is sent to the backup device, this serves as a trigger for analyzing the backup jobs and applying the backup policy. In another example, using a virtual tape model, the device may “in-line decode” the incoming backup streams to locate the property or properties of the backup job from the meta-data embedded in the backup stream by the backup application. Accordingly, deduplication may also be implemented in-line, without having to be stored as non-deduplicated data and then converted for deduplication).

Before continuing, it is noted that although implemented as program code, the components described above with respect to FIG. 2 may be operatively associated with various hardware components for establishing and maintaining a communications links, and for communicating the data between the storage device and the client, and for carrying out the operations described herein.

It is also noted that the software link between components may also be integrated with replication and deduplication technologies. In use, the user can setup replication and/or migration and run these jobs in a user application (e.g., the “backup” application) to replicate and/or migrate data in a virtual cartridge. While the term “backup” application is used herein, any application that supports the desired storage operations may be implemented.

Although not limited to any particular usage environment, the ability to better schedule and manage backup “jobs” is particularly desirable in a service environment where a single virtual storage product may be shared by multiple users (e.g., different business entities), and each user can determine whether to add a backup job to the user's own virtual cartridge library within the virtual storage product.

In addition, any of a wide variety of storage products may also benefit from the teachings described herein, e.g., files sharing in network-attached storage (NAS) or other backup devices. In addition, the remote virtual library (or more generally, “target”) may be physically remote (e.g., in another room, another building, offsite, etc.) or simply “remote” relative to the local virtual library.

Variations to the specific implementations described herein may be based on any of a variety of different factors, such as, but not limited to, storage limitations, corporate policies, or as otherwise determined by the user or recommended by a manufacturer or service provider.

FIG. 3 is a flow diagram 300 illustrating operations which may be implemented for using different storage tiers back on a backup policy. Operations described herein may be embodied as logic instructions on one or more computer-readable medium. When executed by one or more processor, the logic instructions cause a general purpose computing device to be programmed as a special-purpose machine that implements the described operations.

In operation 310, a backup job is received from a client for data on a virtualized storage node. In operation 320, at least one property of the backup job is identified. In operation 330, a backup policy is accessed for the backup job. It is noted that this backup policy may be the only backup policy provided for all backup jobs. Alternatively, multiple backup policies may be provided. For example, the backup policies may be time-based (e.g., backup policies for times of day, or days of the week), or backup policies for different clients (e.g., high-priority servers versus low-priority servers), and so forth. In operation 340, a selection is made between storing data on the plurality of virtualized storage node in a first tier or a second tier based on the backup policy.

Other operations (not shown in FIG. 3) may also be implemented in other embodiments. For example, further operations may include storing the backup job in a first state (e.g., as non-deduplicated data) in the first tier based on the backup policy; and in a second state (e.g., as deduplicated data) in the second tier based on the backup policy. Operations may also include storing at least one backup job in a first state and at least one backup job in a second state without conversion between a first state and a second state. Operations may also include triggering use of the backup policy only when the backup job includes at least one property other than null (or other similar indicator that there are no properties associated with the backup job).

In other examples, the first tier is for non-deduplicated data and the second tier is for deduplicated data. The first tier provides faster restore to the client of the backup job than the second tier. The second tier provides greater storage capacity than the first tier. Of course reference to “first” and “second” is merely used herein to distinguish between at least two different tiers, and does not imply any specific order or association.

The operations enable a user to intelligently control what backup data is stored on the faster tier(s) and what backup data is stored on the slower tier(s). Accordingly, users can meet their restore service level objectives, without having to unnecessarily consume disk space in the fast tier for all of the backup jobs.

It is noted that the terms “fast” (“faster,” “fastest,” and so forth) and “slow” (“slower,” “slowest,” and so forth) are definite in the context of the specific backup systems being implemented and user-desired parameters, but need not be defined in terms of actual or numerical speed or time, because what may be “fast” for one system and/or user may be “slow” for another system and/or user, and may further change over time (e.g., what is considered “fast” at present may be considered “slow” in the future).

The embodiments shown and described are provided for purposes of illustration and are not intended to be limiting. Still other embodiments of using different storage tiers based on a backup policy (or policies) are also contemplated which may satisfy service level objectives for different backup jobs.

1. A method of using different storage tiers based on a backup policy, comprising:
receiving a backup job from a client for data on a plurality of virtualized storage nodes;
identifying at least one property of the backup job;
accessing the backup policy for the backup job; and
selecting between storing incoming data for the backup job on the plurality of virtualized storage nodes in a first tier or a second tier based on the backup policy.

2. The method of claim 1, further comprising storing the backup job in a first state in the first tier based on the backup policy.

3. The method of claim 1, further comprising storing the backup job in a second state in the second tier based on the backup policy.

4. The method of claim 1, further comprising storing at least one backup job in a first state and at least one backup job in a second state without conversion between a first state and a second state.

5. The method of claim 1, wherein the first tier uses non-deduplication and the second tier uses in-line deduplication.

6. The method of claim 1, further comprising providing faster restore of the backup job on the first tier than on the second tier.

7. The method of claim 1, further comprising providing greater storage capacity on the second tier than on the first tier.

8. The method of claim 1, further comprising triggering use of the backup policy only when the backup job includes at least one property other than null.

9. A backup system comprising:
an interface between a plurality of virtualized storage nodes and a client, the interface configured to identify at least one property of a backup job from the client for backing up data on a virtualized storage node in one of at least two states; and
a storage manager operatively associated with the interface, the storage manager configured to manage storing of incoming data for the backup job on the plurality of virtualized storage nodes in either a first tier or a second tier based on a backup policy.

10. The system of claim 9, wherein the at least two states are deduplication format and non-deduplication format.

11. The system of claim 9, wherein the first tier is for fast restore and the second tier is for slow restore.

12. The system of claim 9, wherein the backup policy is user-defined, and the backup policy specifies the state for storing the backup job.

13. The system of claim 9, wherein the at least one property of the backup job is encoded in metadata associated with the backup job, the metadata defining at least two of:
a name of a client device;
a name of the backup job;
a type of the backup job;
an origin of the backup job; and
a capability of a source of the backup job.

14. The system of claim 13, wherein the type of backup job is one of full and incremental.

15. The system of claim 13, wherein the origin of the backup job is one of high priority servers and low priority servers.

16. The system of claim 13, wherein the capability of the source of the backup job is one of deduplication-enabled servers and deduplication-non-enabled servers.

17. A backup system comprising program code stored on computer readable storage and executable by a processor to:
identify at least one property of a backup job from a client for data on at least one virtualized storage node;
access a backup policy; and
select between storing incoming data for the backup job on the at least one virtualized storage node in a first tier or a second tier based on the backup policy.

18. The system of claim 17, wherein the processor further tests a plurality of conditions to identify which tier to store incoming data for the backup job.

19. The system of claim 18, wherein the plurality of conditions include nested conditions.

20. The system of claim 17, wherein the first tier provides faster restore to the client of the backup job than the second tier, and the second tier provides greater storage capacity than the first tier.
